(19) United States
(12) Patent Application Publication
(10) Pub. No.: US 2002/0149474 A1
(43) Pub. Date: Oct. 17, 2002

(54) Electronic sports whistle

(76) Inventor: Max M. Stern, Lake Forest, CA (US)

Correspondence Address: MAX M. STERN, 24284 ONTARIO LANE, LAKE FOREST, CA, 92630, US

(21) Appl. No.: 09/832,433

(22) Filed: Apr. 12, 2001

(51) Int. Cl. G08B 3/00

(52) U.S. Cl. 340/384.73; 340/384.1; 340/384.4; 340/388.1

(57) ABSTRACT

This Invention concerns a device used by an official at a sports event, to produce a whistle like sound, that is hand activated, fitting into the palm of the hand. When activated by that hand, the sound is emitted in all directions, into the surrounding area.

### BACKGROUND OF INVENTION

1. Field of Invention

This invention pertains to the field of sporting events. More particularly it relates to a device that an official uses to confirm a foul or other action, that has taken place on the field of play, by alerting the players, informing other officials and spectators. This allows the game official to call a stop to the play, should he/she desire, until the action has been dealt with according to the rules of the game. When the device is used the next time or again, it signifies play can resume, having taken into account that the penalty for the infringement has been imposed.

2. Description of the Prior Art

In many sporting events, an official or more than one official is on the field or involved with the goings on, on the field of play. They are responsible for seeing that the rules and sportsmanship are adhered to and carried out. In the normal course of the sporting event, at the occurrence or discretion of the official, if a foul or other action, has been observed or taken place, the official blows the whistle, signifying the observance there of and notifying the players, other officials if present and spectators, that appropriate action is going to be metered out.

At sporting events, the pace of the game has been increased in recent years. This requires the official or officials to have to cover a greater amount of distance at a much faster pace. To improve the ability of the official to observe play if possible at all times, breath easier and verbally communicate with others, not requiring putting, or taking out of the mouth, any object such as a whistle, as this device of mine, fits into the palm of the hand, to produce a whistle sound, when activated by pushing on the orbital switch.

It is known in the art, that a whistle like sound can be produced electronically, some are even portable, lightweight and waterproof. However, some of these would not be appropriate in a field sporting event, as some would require adjustments, or are even to heavy, or meant to be applied in a different field. In another instance the whistle sound would be directional, as the body of the official blocks the sound from going into the surrounding area.

It is however, the process to activate the electronics that sets this device apart from previous electronic whistle sound devices, for use in sport, fitting into the palm of the hand and allowing the sound to travel in all directions.

### SUMMARY OF THE INVENTION

This Invention is a means of gaining attention, by using a whistle sound, mainly at sporting events by an official or officials, without having anything in the mouth.

The inventive device would generally include, a housing or handle, electronics, speaker, customized chip, strap or cord, so that it can be carried from the wrist or around the neck, with in this case, a unique orbital switch, configured around the top portion of the handle.

This latter piece of the device, the orbital 360 degree switch, is yieldable, by pushing at any point around its axis, about the handle, to complete the circuit. This action causes the components, to deliver the whistle like sound, through the speaker, otherwise this switch is in a neutral mode about said handle.

Accordingly, the main object of the invention is a simple and expeditious means of activation of the electronics to create a whistle sound, such that the official need not use their mouth or take their eyes from the playing area.

These and other objects of the invention like the compactness, ease of use, replacing of the power source, will become more apparent upon reading the description of the preferred embodiments, taken with the drawings appended hereto. The scope and protection sought by the inventor may be gleamed from a reading of the claims that conclude this application.

### DESCRIPTION OF THE DRAWINGS

FIG. 1 is an exterior, front view of the device, showing the housing, or actual handle, that is produced from a hard rubber compound, with the orbital 360 degree switch placed near the top portion, a speaker, cord and battery replacement cap.

FIG. 2 is an illustrative, cut through sectional view of the components, with the orbital switch, a part of the embodiment as shown in FIG. 1.

FIG. 3 is an exploded view of the orbital switch allowing for greater detail of the switch to be displayed and viewed.

### Referance Numerals in Drawings

1) housing or handle (made of a hard rubber compound)

2) orbital 360 degree switch

3) speaker

4) cord or band

5) electronics

6) control board

7) microchip

8) battery

9) resisters

10) connection between battery and control board

11) connection between element plate and control board

12) connection between element plate inside switch from battery

13) connection from electronics to speaker

14) exit opening from housing

15) entry to housing

16) attachment for keeping element plate in position

17) element plate around the outside perimeter of handle

18) element plate encompassing the inside for 360 degrees of orbital switch

19) springs

20) post to keep spring in position

21) L shaped protrusion from handle

22) curved arm of switch

23) rubber gasket

24) screw cap for battery replacement

### DESCRIPTION OF THE PREFERRED EMBODIMENTS

Looking at the actual drawings like elements are identified by like numbers, throughout, the 3 drawings.

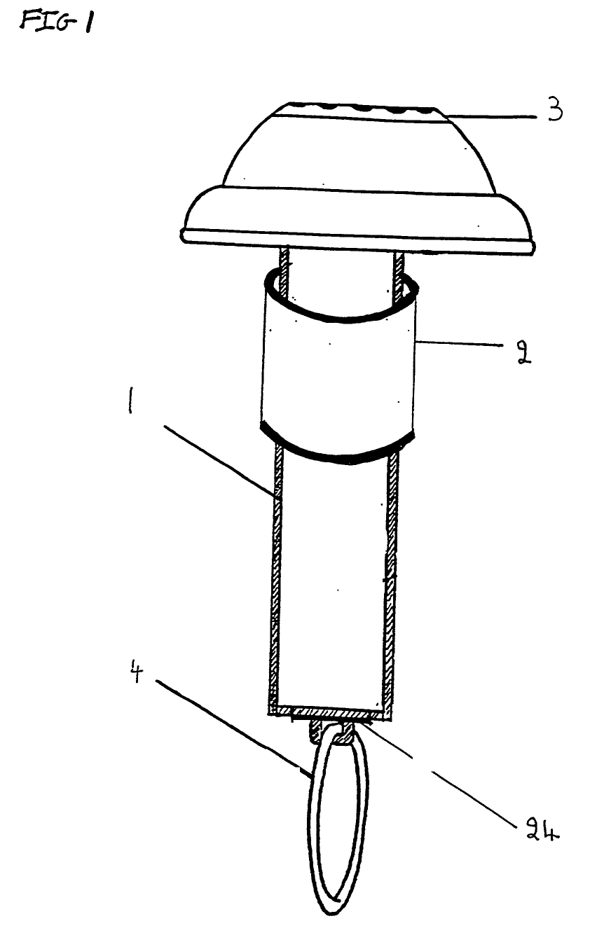

FIG. 1 shows the housing 1, (manufactured of a hard rubber compound) with the orbital switch 2, in a neutral position. When activated anywhere around it's 360 degree, the switch 2, will cause said whistle like sound to be emulated, from the speaker 3, at the top end of the housing 1, while from the other end, the screw cap for battery replacement 24, is easy to access. Besides fitting into the palm of the hand and activated by that same hand, it can be worn on the wrist or around the neck by the cord or band 4.

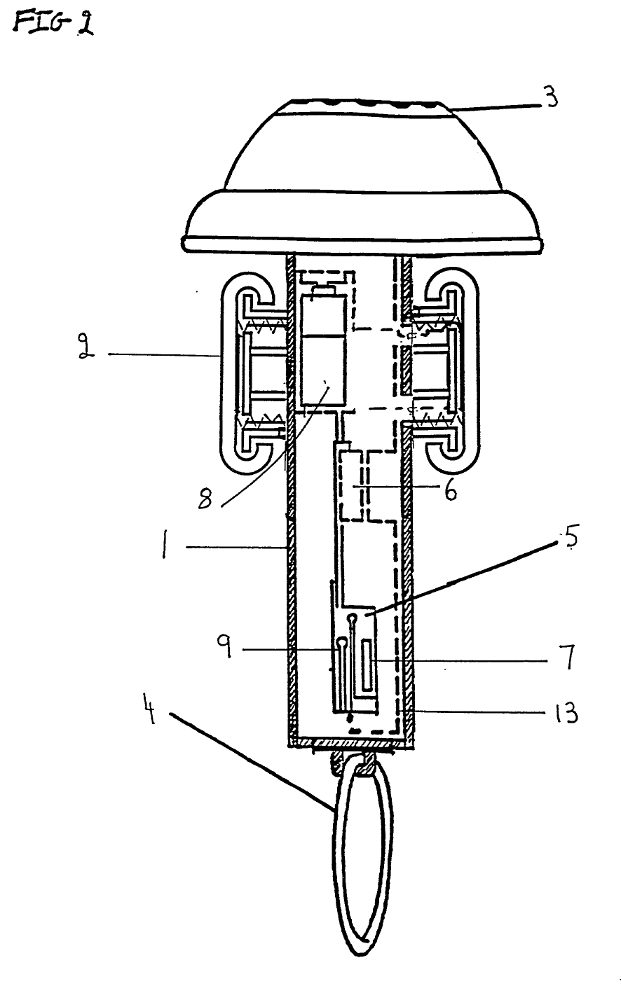

FIG. 2 shows the layout of all the components on and inside the handle, with the orbital switch 2, located towards the upper part of the handle 1. The power for this device comes from a battery 8, connected to various components, such as the control board 6, electronics 5, which is comprised of a customized microchip 7, to produce the whistle like sound, transistors 9, included in this connection is an open ended circuit to the actual orbital switch 2, and back to the control board 6, activation is achieved when both of the element plates come into contact with each other. When this circuit is completed the electronics 5, have a connection from the electronics to the speaker 13, so the actual speaker 3 can distribute the sound. The cord or band 4, at the base of the handle 1, can clearly be seen for carrying or wearing around the neck.

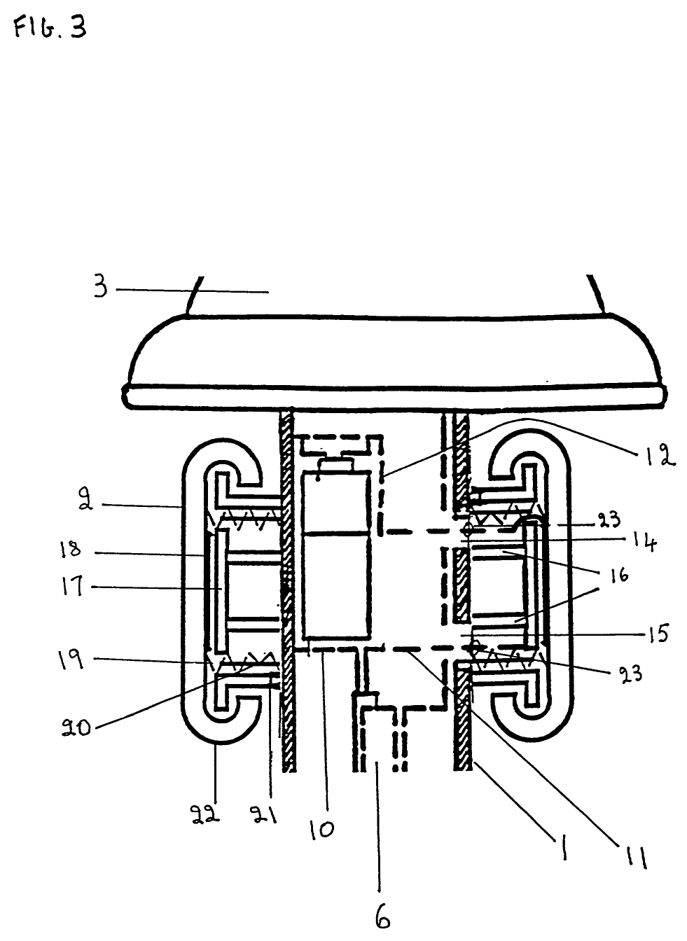

The orbital 360 degree switch 2, on the upper section of the housing 1, has been enlarged in FIG. 3, to expose the internal components, that comprise this switch 2, with the details more clearly visible on how this orbital 360 switch 2, is passive until activated, and the route the electricity follows to complete the circuit to create the whistle sound, that is emitted from the speaker 3, into the surrounding area.

A portion of the circuit that is open, until activation takes place, runs from the battery 8, to the plate element inside the switch 12, the connection passes through an exit opening 14, via a rubber gasket 23, to reach the plate element encompassing the inside of the orbital 360 degree switch 18, of said switch 2. When said switch 2, is pushed anywhere about it's surface, the plate element encompassing the inside for 360 degrees of switch 18, makes contact with the plate element around the outside perimeter of the handle 17, which is attached with posts for keeping the handle plate element in position 16, the circuit between the handle plate element and the control board 11, are completed when passing through the entry opening in the housing 15, via a rubber gasket 23, to the control board 6. This allows for the positive terminal of the battery 8, to complete the circuit to the control board 6. The negative connection 10, from the battery 8, to the control board 6, is a straight connection, that only requires the circuit to be closed to deliver power, for the sound of a whistle to be heard coming from the speaker 3.

The means to keep the orbital 360 degree switch 2, in a neutral mode, is achieved by including various features on the handle 1, such as; L shaped protrusions from the handle 21, that are strategically placed about said handle 1, at four locations spaced 90 degrees apart around the top axis as well as around the lower axis, comprising a total of eight. The orbital switch 2, has springs 19, that surround posts to keep the springs 19 in position 20, these are located inside the L shaped protrusions from the handle 21, at the same eight location on the handle 1, at the top and lower axis of the switch 2. The springs 19, put tension against the orbital switch 2, keeping the orbital switch 2, in a neutral position, until sufficient pressure is applied upon any portion of the outside surface of the switch 2, so that when contact is established, with the element plates touching, the circuit is complete, whereby the sound of a whistle will be produced, coming from the speaker 3.

While the invention has been described with reference to a particular embodiment thereof, those skilled in the art will be able to make various modifications to the described embodiments without departing from the true scope thereof. It is intended that all combinations of elements and steps, which perform the same function, are within the scope of this invention.

What is claimed is:

1. In a field sporting event, an electronic device for confirming an officials call, by creating a whistle like sound comprising:
a) a handle housing shaped to fit into the palm of the hand;
b) in the housing are components;
c) a speaker at one end of the handle housing for sound distribution;
d) a switch means for activation of said sound.

2. The device of claim 1 wherein said activation means is integral with said handle.

3. The device of claim 1 wherein switch means includes an orbital activation member.

4. The device of claim 3 wherein switch means is activated by the same hand that is holding the housing that creates the whistle sound.

5. The device of claim 1 wherein said handle has switch means located near the upper end of said handle housing comprising:
a) a first wire connection as the conductor to outside circular plate element of said circular switch means from power source;
b) a second wire connection as the conductor from the inside plate element sleeve around the handle to the components;
c) a said means for holding switch means in a neutral position;
d) said switch being activated by pressing against switch at any location point 360 degrees about said handle, to bring said outside plate element into contact with handle plate element sleeve to complete circuit of said components to produce a whistle sound.

6. The device of claim 1 when said sound is emitted from the speaker, it can be heard all around the field of play, as it is not directional.

7. The device of claim 5 wherein said power source includes a battery.
